(19) United States
(12) Patent Application Publication
(10) Pub. No.: US 2002/0085018 A1
(43) Pub. Date: Jul. 4, 2002

(54) Method for reducing chinese character font in real-time

(76) Inventor: Ha Chun Chien, Taipei (TW)

Correspondence Address: BACON & THOMAS, PLLC, 625 Slaters Lane - 4th Floor, Alexandria, VA, 22314-1176, US

(21) Appl. No.: 09/753,486

(22) Filed: Jan. 4, 2001

(51) Int. Cl. G09G 5/00

(52) U.S. Cl. 345/667

(57) ABSTRACT

A method for reducing Chinese character fonts in real-time display on a monitor of an electronic calculating machine in real-time is disclosed. The Chinese dot matrix characters have a plurality of column pixels and row pixels according to an original predetermined dot matrix font size. The method has steps of: assigning coordinate numbers to each column pixel and row pixel of the Chinese dot matrix character according to an arrangement sequence; storing a plurality of predetermined reduced Chinese dot matrix characters size formats; receiving a request for reducing a Chinese dot matrix characters font size to one of the predetermined reduced Chinese dot matrix character font sizes; setting a plurality of adjacent two column coordinate numbers and two row coordinate numbers as two predetermined operating units; and performing a plurality of OR operations on adjacent two column pixels and two row pixels to generate a reduced Chinese dot matrix character font.

### BACKGROUND OF THE INVENTION

1. Field of the Invention

The present invention relates to a method for reducing Chinese character font and, more particularly, to a method for reducing Chinese character font in real-time displayed on a monitor of an electronic calculating machine in real-time.

2. Description of Related Art

A common Chinese displaying system has reducing and magnifying functionality of character font size to allow user to adjust the character font display according to personal preference. Normally, Chinese character fonts are divided into Chinese vector character and Chinese dot matrix character by the storage methods of each character. Please refer to FIG. 1. FIG. 1 is a schematic diagram of a prior art method for reducing Chinese dot matrix character font size. In the prior art method, a character font database is established for storing all Chinese characters having several different reduced character fonts. When a user decides to reduce the character font size of a Chinese character, the Chinese displaying system finds a matched reduced character font size for the Chinese character in the character font database. However, the number of Chinese characters is enormous, so even without considering the huge memory capacity required for the character font size databases needed to provide several different reduced character fonts for every Chinese character. The requirements are still quite large. Therefore, the manufacturing cost to include numerous font sizes will be increased.

Please refer to FIG. 2. FIG. 2 is a schematic diagram of another prior art method for reducing Chinese dot matrix character font sizes, such as reducing [symbol] and [symbol] two Chinese characters. In this existing prior art method for reducing Chinese dot matrix character font size, some column pixels and some row pixels of dot matrix character font of all Chinese are predetermined to be the removed objectives. When a user decides to reduce the character font size of a Chinese character, the Chinese character font removes the predetermined removed objectives to reduce the character font. However, as shown in FIG. 2, for some Chinese characters, the predetermined removed objectives could end up being the main characteristics of the character. For this reason, [symbol] and [symbol] these two Chinese characters lost their main characteristics for character meaning, and even cannot be recognized after being reduced.

Therefore, it is desirable to provide an improved character recognition method to mitigate and/or obviate the aforementioned problems.

### SUMMARY OF THE INVENTION

The main object of the present invention is to provide a method for reducing Chinese character font in real-time enabling Chinese dot matrix characters displayed on a monitor of an electronic calculating machine to be displayed in a reduced dot matrix font size.

To achieve the object, the method of the present invention includes: assigning coordinate numbers to each column pixel and row pixel of Chinese dot matrix characters font according to an arrangement sequence; storing a plurality of predetermined font size formats for reduced Chinese dot matrix characters font; receiving a request for reducing the Chinese dot matrix characters font size into one of the predetermined reduced Chinese dot matrix characters font sizes; setting a plurality of adjacent two column coordinate numbers and two row coordinate numbers as a predetermined operating unit; and performing a plurality of OR operations on adjacent two column pixels and two row pixels to generate a reduced Chinese dot matrix character font; wherein the number of adjacent two column pixels and row pixels is equal to the difference between the number of pixels in the original predetermined dot matrix character font size and the reduced dot matrix character font size for the columns and rows, respectively.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a prior art method for reducing Chinese dot matrix character font size.

FIG. 2 is a schematic diagram of another prior art method for reducing Chinese dot matrix character font, such as reducing [symbol] and [symbol] two Chinese characters.

FIG. 3 shows a flowchart of the method of the present invention.

FIG. 4 is a schematic diagram of an OR operation of the method of the present invention.

FIG. 5 is a schematic diagram of reducing a [symbol] character font in a 16*16 dot matrix format to a 12*12 dot matrix format according to the present invention.

FIG. 6 is a schematic diagram of reducing a [symbol] character font in a 16*15 dot matrix format to a 12*11 dot matrix format according to the present invention.

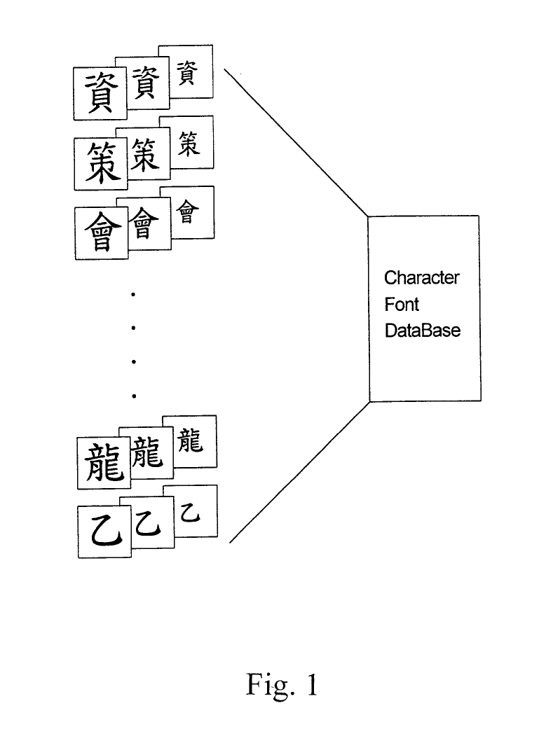

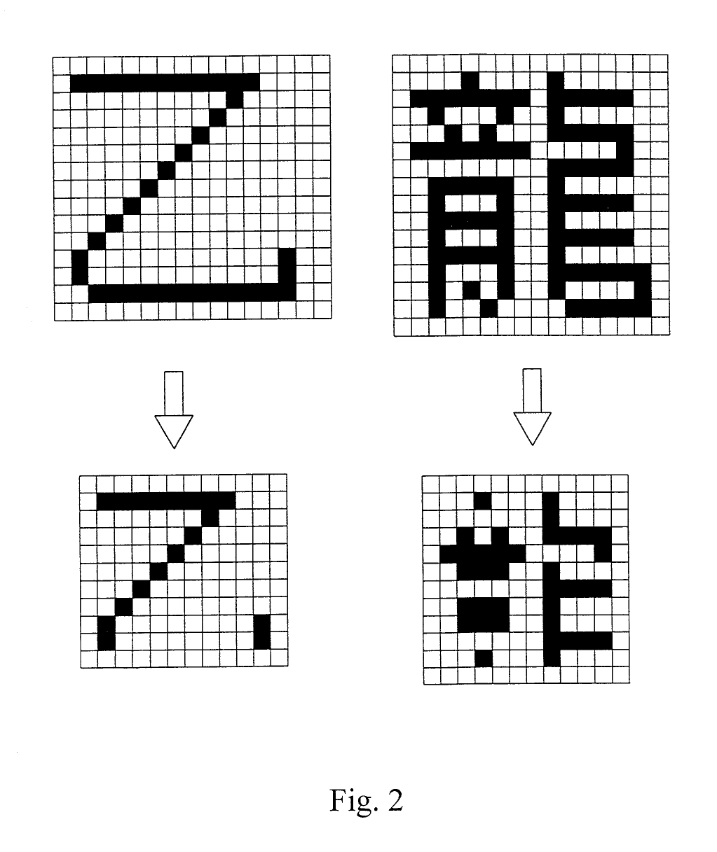

### DETAILED DESCRIPTION OF THE PREFERRED EMBODIMENT

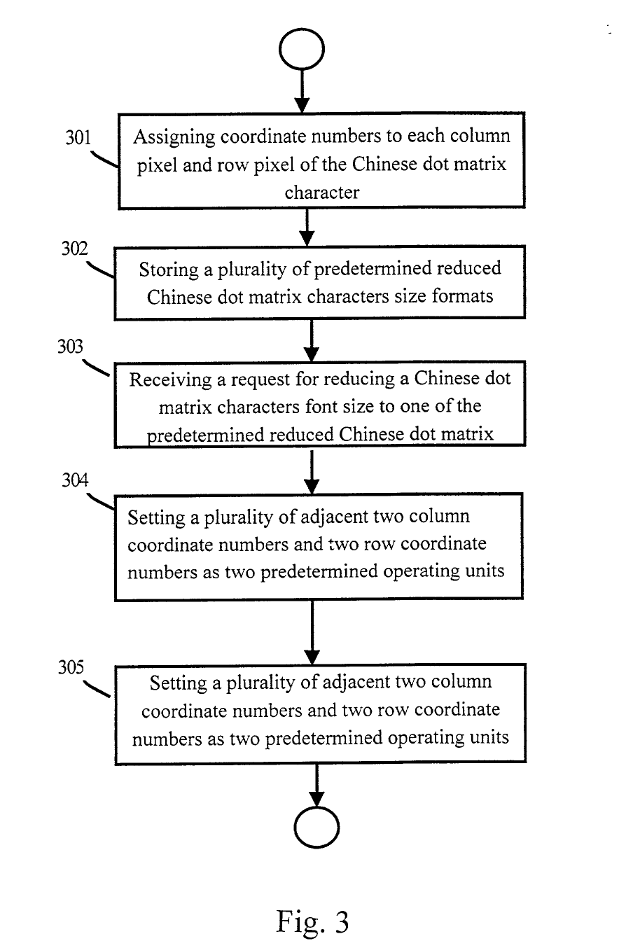

Please refer to FIG. 3. FIG. 3 shows a flowchart of the method of the present invention. In the present invention, the Chinese character is displayed in dot matrix font. The Chinese dot matrix characters have a plurality of column pixels and row pixels according to an original predetermined dot matrix font size, such as 16*16 font format. The method for reducing Chinese character font size comprises:

Step 301: numbering the column pixel and row pixel of the Chinese dot matrix character font. Assigning coordinate numbers to each column pixel and row pixel of the Chinese dot matrix character font, according to an arrangement sequence.

Step 302: storing a plurality of predetermined font size formats for reduced Chinese dot matrix characters font. Setting a plurality of reduced dot matrix characters font size format, such as 12*12 [symbol] 8*8 etc. to provide a plurality of different font size formats.

Step 303: receiving a request for reducing the Chinese dot matrix characters font size into one of the predetermined reduced Chinese dot matrix characters font size formats. According to the predetermined font size formats for reduced Chinese dot matrix characters font size, a user can choose a predetermined font size format by different inputting manners.

Step 304: setting a plurality of adjacent two column coordinate numbers and two row coordinate numbers as a predetermined operating unit.

Step 305: performing a plurality of OR operations on adjacent two column pixels and two row pixels to generate a reduced Chinese dot matrix character font. The following section will explain more about all of the OR operations.

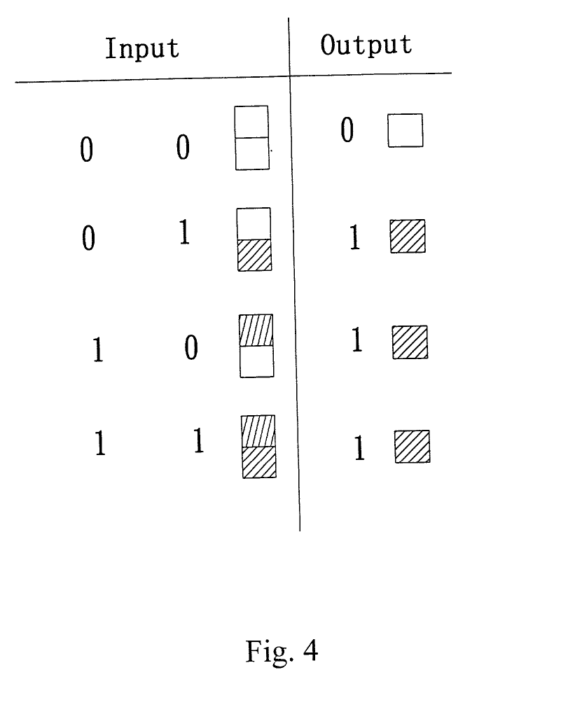

Please refer to FIG. 4. FIG. 4 is a schematic diagram of an OR operation of the method of the present invention. As shown in FIG. 4, when performing the OR operations, there are four operation combinations: 1. When two input operators of the OR operation both are 0, the output result is 0, which means both the adjacent two predetermined operating units are blank pixels, so the combined pixel will be blank. 2. When two input operators of the OR operation are 0 and 1, which means the adjacent two predetermined operating units are a blank pixel and a filled pixel, so the combined pixel will be filled. 3. When two input operators of the OR operation are 1 and 0, which means the adjacent two predetermined operating units are a filled pixel and a blank pixel, so the combined pixel will be filled. 4. When two input operators of the OR operation both are 1, the output result is 1, which means both the adjacent two predetermined operating units are filled pixels, so the combined pixel will be filled.

Since the present invention is to enable a plurality of Chinese dot matrix characters displayed on a monitor of an electronic calculating machine to be displayed in a reduced dot matrix font size in real-time, the electronic calculating machine needs to have a storage unit for storing all Chinese dot matrix characters in an original dot matrix font size to display Chinese information. The inventor of the present invention selects a plurality of pixels presenting less important parts of most Chinese characters to be the predetermined operating units. Wherein the number of adjacent two column pixels and row pixels is equal to the difference between the number of pixels in the original predetermined dot matrix character font size and the reduced dot matrix character font size for the columns and rows, respectively, the inventor sets different number of two predetermined operating units for different predetermined dot matrix character font. According to the character structure of most Chinese characters, the inventor finds the less influential common parts to be the predetermined operating units. Furthermore, the method of the present invention is applied to both traditional Chinese character forms and simplified Chinese character forms.

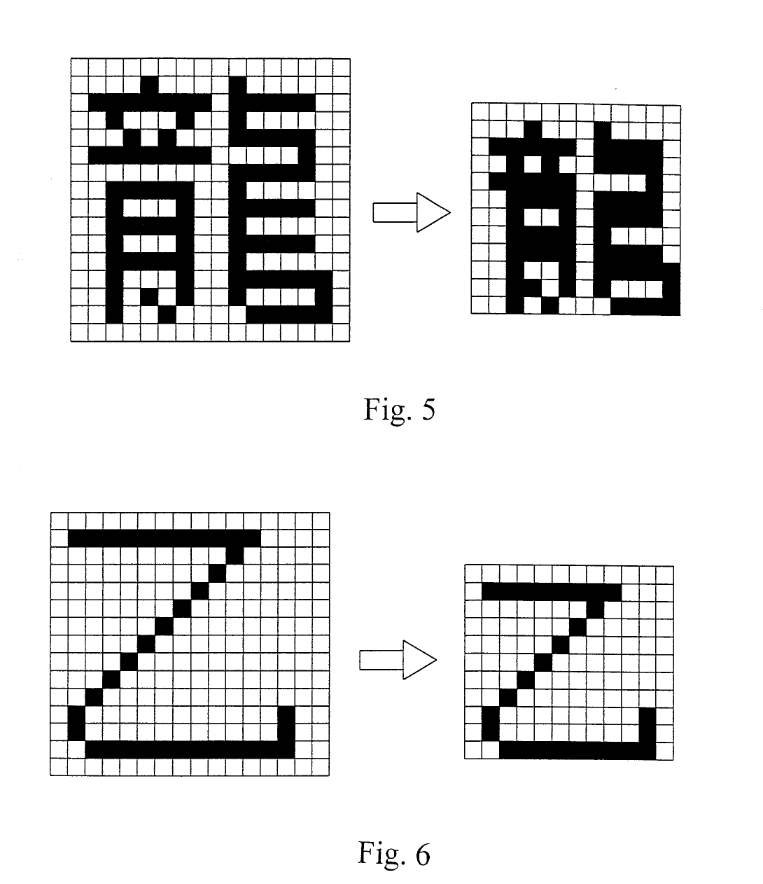

Please refer to FIG. 5 and FIG. 6. FIG. 5 is a schematic diagram of reducing a [symbol] character font in a 16*16 dot matrix font format to a 12*12 dot matrix font format according to the present invention. FIG. 6 is a schematic diagram of reducing a [symbol] character font in 16*15 dot matrix font format to a 12*11 dot matrix format according to the present invention. As shown in FIG. 5, the column pixels [3,4] [symbol] [7,8] [symbol] [11,12] [symbol] [15,16] and the row pixels [3,4] [symbol] [7,8] [symbol] [11,12] [symbol] , [15,16] of a [symbol] character font in a 16*16 dot matrix font format are performing the OR operation to obtain a [symbol] character font in a 12*12 dot matrix font format. Similarly, as shown in FIG. 6, the column pixels [3,4] [symbol] [7,8] [symbol] [11,12] [symbol] [15,16] and the row pixels [3,4] [symbol] - [7,8] [symbol] - [11,12] [symbol] [14,15] of a [symbol] character font in a 16*16 dot matrix font format are performing the OR operation to obtain a [symbol] character font in a 12*12 dot matrix font format.

As the result illustrated in the drawing shows, the reduced [symbol] character font is comprehensible and keeps the main characteristics for the character meaning. Although, the reduced [symbol] character font is not completely identical with the original character font, the reduced [symbol] character keeps the main part of the character meaning. Therefore, most readers still can recognize clearly the reduced character font. In summary, the above-mentioned content, shows the present invention only needs to store different reduced dot matrix character font size formats and perform the OR operation on predetermined operating units. Therefore, the method of the present invention does not need huge memory capacity to store different character font sizes, and will not be misunderstood by removing directly some of the pixels of the dot matrix font.

Furthermore, the electronic calculating machine can be a personal computer, an information apparatus a mobile phone or any electronic device with networking functionality.

The computer program should perform the above-mentioned method of the present invention. The system of the present invention can be stored as a computer program on a computer readable medium such as a hard disk, a floppy disk, an integrated circuit, a compact disk and other computer readable media. Therefore, it is unnecessary to describe more about the technology of the programming process.

Although the present invention has been explained in relation to its preferred embodiment, it is to be understood that many other possible modifications and variations can be made without departing from the spirit and scope of the invention as hereinafter claimed.

What is claimed is:

1. A method for reducing Chinese character font in real-time enabling a plurality of Chinese dot matrix characters displayed on a monitor of an electronic calculating machine to be displayed in a reduced dot matrix font size, the Chinese dot matrix characters having a plurality of column pixels and row pixels according to an original predetermined dot matrix font size, the method comprising:
assigning coordinate numbers to each column pixel and row pixel of the Chinese dot matrix character, according to an arrangement sequence;
storing a plurality of predetermined reduced Chinese dot matrix characters size formats;
receiving a request for reducing a Chinese dot matrix character font size to one of the predetermined reduced Chinese dot matrix character font sizes;
setting a plurality of adjacent two column coordinate numbers and two row coordinate numbers as two predetermined operating units; and
setting a plurality of adjacent two column coordinate numbers and two row coordinate numbers as two predetermined operating units;
wherein the number of adjacent two column pixels and row pixels is equal to the difference between the number of pixels in the original predetermined dot matrix character font size and the reduced dot matrix character font size for the columns and rows, respectively.

2. The method of claim 1, wherein the electronic calculating machine stores all Chinese characters using the original predetermined dot matrix font

3. The method of claim 1, wherein every pixel is fully blank or fully filled.

4. The method of claim 1, wherein the Chinese dot matrix characters are applied to both traditional Chinese character forms and simplified Chinese character forms.

5. The method of claim 1, wherein the electronic calculating machine is a personal computer, an information apparatus, a mobile phone or an electronic device with networking functionality.
